(19) United States
(12) Patent Application Publication
(10) Pub. No.: US 2012/0107600 A1
(43) Pub. Date: May 3, 2012

(54) TRANSPARENT CONDUCTIVE FILM COMPRISING CELLULOSE ESTERS

(76) Inventor: Chaofeng Zou, Maplewood, MN (US)

(21) Appl. No.: 13/382,176

(22) PCT Filed: Mar. 19, 2010
(86) PCT No.: PCT/US10/00818

§ 371 Date: Jan. 4, 2012

Related U.S. Application Data
(60) Provisional application No. 61/226,380, filed on Jul. 17, 2009.

(51) Int. Cl. B32B 15/08; B82Y 99/00

(52) U.S. Cl. 428/301.1; 977/762

(57) ABSTRACT

Transparent conductive films comprising silver nanowires dispersed in cellulose ester polymers can be prepared by coating from organic solvent using common solvent coating techniques. These films have good transparency, conductivity, and stability. Coating on a flexible support allows the manufacture of flexible conductive materials.

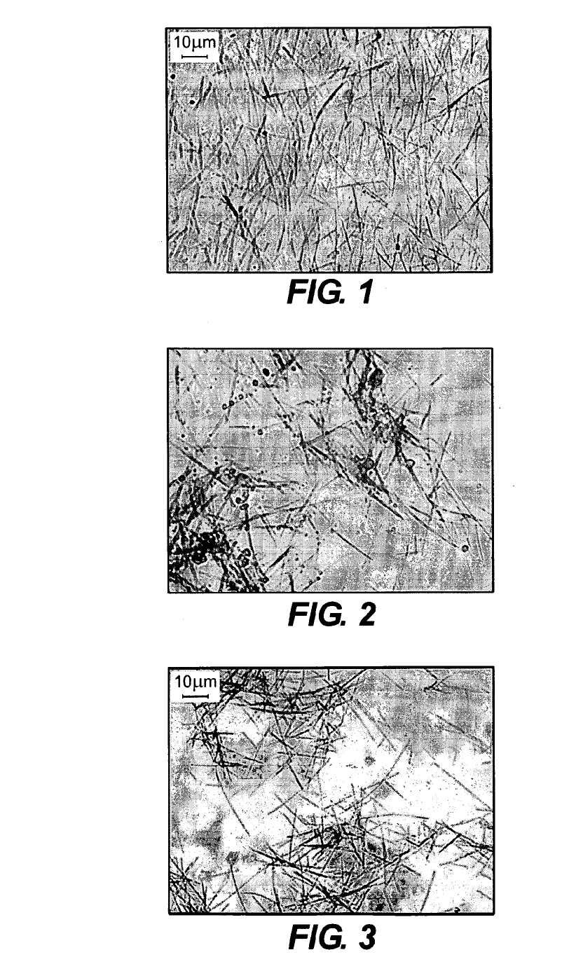

### FIELD OF THE INVENTION

This invention relates to transparent electrically conductive films comprising a random network silver nanowires and cellulose esters, and to methods of manufacturing and using these films.

### BACKGROUND OF THE INVENTION

Transparent and electrically conductive films have been used extensively in recent years in applications of touch panel display, liquid crystal display, electroluminescent lighting, organic light-emitting diode device, photovoltaic solar cell. Indium tin oxide (ITO) based transparent conductive film has been the transparent conductor-of-choice for most applications until recently due to its high conductivity, transparency, and relatively good stability. However, indium tin oxide based transparent conductive films have limitation due to the high cost of indium, the need for complicated and expensive vacuum deposition equipment and processes, and its inherent brittleness and tendency to crack, especially when indium tin oxide is deposited on flexible substrates.

Two of the most important parameters for measuring the properties of transparent conductive films are total light transmittance (% T) and film surface electric conductivity. Higher light transmittance allows clear picture quality for display applications, higher efficiency for lighting and solar energy conversion applications. Lower resistivity is most desirable for most transparent conductive films applications in which power consumption can be minimized. Therefore, the higher the T/R ratio of the transparent conductive films is, the better the transparent conductive films are.

T/R Ratio=(% total transmittance)/(film surface resistivity)

U.S. Patent Application Publication 2006/0257638A1 describes a transparent conductive film comprising carbon nanotubes (CNT) and vinyl chloride resin binder. The resulting transparent conductive film had T/R ratio raging from 3×10⁻⁹ to 7.05.

U.S. Patent Application Publications 2007/0074316A1 and 2008/0286447A1 describe a transparent conductive film in which silver nanowires are deposited onto a substrate to form a bare nanowire network followed by overcoating the silver nanowire network with a polymer matrix material to form a transparent conductive film. Polymer materials such as polyacrylates and carboxyl alkyl cellulose polymers were suggested as useful materials for the matrix.

U.S. Patent Application Publication 2008/0292979 describes a transparent conductive film comprising silver nanowires, or a mixture of silver nanowires and carbon nanotubes. The transparent conductive network is formed either without binder or in a photoimageable composition. The transparent and conductive films were coated on both glass and PET supports.

U.S. Patent Application Publication 2009/0130433A1 describes a transparent conductive film which is formed from coating of silver nanowires to form a network followed by overcoating with a layer of urethane acrylate binder.

It would be desirable to be able to prepare transparent conductive films in one-step by coating a polymer dispersion of silver naonwires from an organic solvent. The polymer should be readily soluble in organic solvent, capable of facilitating the dispersion of silver nanowires in organic solvent, and could form strong and durable film in the presence of silver nanowires.

### SUMMARY OF THE INVENTION

The invention provides a transparent conductive film comprising a random network of silver nanowires dispersed within a transparent cellulose ester polymer.

The invention also provides a transparent conductive film comprising a random network of silver nanowires dispersed within a transparent cellulose ester polymer and a second polymer.

The invention also provides a transparent conductive article comprising: a transparent support having a transparent conductive film comprising a random network of silver nanowires dispersed within a cellulose ester polymer coated thereon.

The invention further provides a process for the formation of a transparent conductive article comprising preparing a dispersion of silver nanowires in a solution of a cellulose ester polymer; coating the dispersion onto a transparent support; and drying the coating on the support thereby forming a random network of silver nanowires.

The invention still further provides a process for the formation of a transparent conductive film comprising: preparing a dispersion of silver nanowires in a solution of a cellulose ester; and coating and drying the dispersion thereby forming a random network of silver nanowires.

The invention also provides a transparent conductive article comprising a transparent support having coated thereon; a carrier layer comprising a single-phase mixture of two or more polymers; and a transparent conductive film comprising a random network of silver nanowires dispersed within a cellulose ester polymer.

The invention still further provides a process for the formation of a transparent conductive article comprising preparing a dispersion of silver nanowires in a solution of a cellulose ester polymer; preparing a carrier layer formulation comprising a single-phase mixture of two or more polymers; coating the carrier layer formulation onto a transparent support; coating the dispersion of silver nanowires in a solution of a cellulose ester polymer, onto the carrier layer; and drying the coating on the support thereby forming a random network of silver nanowires.

Other aspects, advantages, and benefits of the present invention are apparent from the detailed description, examples, and claims provided in this application.

### BRIEF DESCRIPTION OF THE FIGURES

FIG. I is a photomicrograph of a transparent conductive film coated using cellulose acetate butyrate as the binder as described in Example 6.

FIG. II is a photomicrograph of a transparent conductive film coated using polyvinyl butyral as the binder as described in Example 9.

FIG. III is a photomicrograph of a transparent conductive film coated using polyurethane as the binder as described in Example 10.

### DETAILED DESCRIPTION OF THE INVENTION

Priority is claimed from Provisional Application No. 61/226,380, entitled NANOWIRE-BASED TRANSPARENT CONDUCTIVE FILMS COMPRISING CELLULOSE ESTERS, filed on Jul. 17, 2009 in the name of Chaofeng Zou, incorporated herein by reference.

### DEFINITIONS

The terms “conductive layer” or “conductive film” refer to the network layer comprising silver nanowires dispersed within a cellulose ester polymer.

The term “conductive” refers to electrical conductivity.

The term “article” refers to the coating of a “conductive layer” or “conductive film” on a support.

The terms “coating weight”, “coat weight”, and “coverage” are synonymous, and are usually expressed in weight or moles per unit area such as g/m² or mol/m².

The term “transparent” means capable of transmitting visible light without appreciable scattering or absorption.

“Haze” is wide-angle scattering that diffuses light uniformly in all directions. It is the percentage of transmitted light that deviates from the incident beam by more than 2.5 degrees on the average. Haze reduces contrast and results in a milky or cloudy appearance. The lower the haze number, the less hazy the material.

The term “organic solvent,” means “a material, liquid at use temperature, whose chemical formula comprises one or more carbon atoms.”

The terms “a” or “an” refer to “at least one” of that component (for example, the anti-corrosion agents, nanowires, and polymers described herein). Thus, the term “a random network of silver nanowires” can refer to one or more networks within a coating.

Furthermore, all publications, patents, and patent documents referred to in this document are incorporated by reference herein in their entirety, as though individually incorporated by reference.

### The Silver Nanowires:

The silver nanowires are essential component for imparting electrical conductivity to the conductive films, and to the articles prepared using the conductive films. The electrical conductivity of the transparent conductive film is mainly controlled by a) the conductivity of a single nanowire, b) the number of nanowires between the terminals, and c) the connectivity between the nanowires. Below a certain nanowire concentration (also referred as the percolation threshold), the conductivity between the terminals is zero, as there is no continuous current path provided because the nanowires are spaced too far apart. Above this concentration, there is at least one current path available. As more current paths are provided, the overall resistance of the layer will decrease. However, as more current paths are provided, the percent of light transmitted through the conductive film decreases due to light absorption and scattering by the nanowires. Also, as the amount of silver nanowires in the conductive film increases, the haze of the transparent film increases due to light scattering by the silver nanowires. Similar effects will occur in transparent articles prepared using the conductive films.

In one embodiment, the silver nanowires have aspect ratio (length/width) of from about 20 to about 3300. In another embodiment, the silver nanowires have an aspect ratio (length/width) of from about 500 to 1000. Silver nanowires having a length of from about 5 μm to about 100 μm (micrometer) and a width of from about 30 nm to about 200 nm are useful. Silver nanowires having a width of from about 50 nm to about 120 nm and a length of from about 15 μm to about 100 μm are also useful for construction of a transparent conductive network film.

Silver nanowires can be prepared by known methods in the art. In particular, silver nanowires can be synthesized through solution-phase reduction of a silver salt (e.g., silver nitrate) in the presence of a polyol (e.g., ethylene glycol or propylene glycol) and poly(vinyl pyrrolidone). Large-scale production of silver nanowires of uniform size can be prepared according to the methods described in, e.g., Ducamp-Sanguesa, C. et al, J. of Solid State Chemistry, (1992), 100, 272-280; Xia, Y. et al., Chem. Mater. (2002), 14, 4736-4745; and Xia, Y. et al., Nanoletters, (2003), 3(7), 955-960.

### The Cellulosic Ester Binder:

For a practical manufacturing process for transparent conductive films, it is desirable and important to have both the conductive components, such as silver nanowires, and a polymer binder in a single coating solution. The polymer binder solution serves a dual role, as dispersant to facilitate the dispersion of silver nanowires and as a viscosifier to stabilize the silver nanowire coating dispersion so that the sedimentation of silver nanowires does not occur at any point during the coating process. This simplifies the coating process, and allows for a one-pass coating, and avoids the method of first coating bare silver nanowires to form a weak and fragile film that is subsequently over-coated with a polymer to form the transparent conductive film.

In order for a transparent conductive film to be useful in various device applications, it is also important that the binder of the transparent conductive film to be optically transparent and flexible; yet have high mechanical strength, hardness, and good thermal and light stability. It is also desirable that polymer binders for transparent conductive film contain functional groups having N, O, S or other elements with lone pair electrons to provide good coordination bonding for stabilization of silver nanowires during the dispersion and coating of silver nanowire and polymer solution.

Therefore, it is advantageous to use polymer binders having a high oxygen content, such as hydroxyl groups and carboxylate groups. These polymers have a strong affinity for the silver nanowire surface and facilitate the dispersion and stabilization of silver nanowires in the coating solution. Most oxygen-rich polymers also have the added benefit of having good solubility in the polar organic solvents commonly used to prepare organic solvent-coated thin films.

Cellulose ester polymers, such as cellulose acetate butyrate (CAB), cellulose acetate (CA), or cellulose acetate propionate (CAP) are superior to other oxygen-rich polymer binders when used to prepare silver nanowire based transparent conductive films, and coated from organic solvents, such as 2-butanone (methyl ethyl ketone, MEK), methyl iso-butyl ketone, acetone, methanol, ethanol, 2-propanol, ethyl acetate, or mixtures thereof. Their use results in transparent conductive films in which both the light transmittance and electrical conductivity of the coated films are greatly improved. In addition, these cellulose ester polymers have glass transition temperatures of at least 100° C., can form transparent and flexible films having high mechanical strength and hardness, and have high thermal and light stability. In contrast, similarly prepared transparent conductive films employing polyurethane or polyvinyl butyral polymeric binders show less desirable transmittance and conductivity.

The cellulose ester polymers are present in from about 40 to about 90 wt % of the dried transparent conductive films. Preferably, they are present in from about 60 to about 85 wt % of the dried films.

In some constructions, up to 50 wt % of the cellulosic ester polymer can be replaced by one or more additional polymers. These polymers should be compatible with the cellulosic polymer. By compatible is meant that the polymers form a transparent, single phase mixture when dried. The additional polymer or polymers can provide further benefits such as promoting adhesion to the support and improving hardness and scratch resistance. As above, total wt % of all polymers is from about 50 to about 90 wt % of the dried transparent conductive films. Preferably, the total weight of all polymers is from about 70 to about 85 wt % of the dried films. Polyester and polyacrylic polymers, are examples of useful additional polymers.

### Coating of the Conductive Films:

An organic solvent-based coating formulation for the transparent silver nanowire films can be prepared by mixing the various components with one or more binders in a suitable organic solvent system that usually includes one or more solvents such as toluene, 2-butanone (methyl ethyl ketone, MEK), methyl iso-butyl ketone, acetone, methanol, ethanol, 2-propanol, ethyl acetate, propyl acetate, ethyl lactate, or tetrahydrofuran, or mixtures thereof. Methyl ethyl ketone is a particularly useful coating solvent. Transparent films containing silver nanowires can be prepared by coating organic solvent formulations using various coating procedures such as wire wound rod coating, dip coating, air knife coating, curtain coating, slide coating, slot-die coating, roll coating, gravure coating, or extrusion coating. Surfactants and other coating aids can be incorporated into the coating formulation.

In one embodiment, the coating weight of the silver nanowires is from about 20 mg/m² to about 500 mg/m². In another embodiment, the coating weight of silver nanowires is from about 20 mg/m² to about 200 mg/m². In a further embodiment, the coating weight of silver nanowires is from about 30 mg/m² to about 120 mg/m². A useful coating dry thickness of the transparent conductive coating is from about 0.05 μm to about 2.0 μm, and preferably from about 0.2 μm to about 1.0 μm.

Upon coating and drying, the transparent conductive film should have a surface resistivity of less than 1,000 ohms/sq and preferably 500 ohm/sq or less.

Upon coating, and drying, the transparent conductive film should have as high a % transmittance as possible. A transmittance of at least 70% is useful. A transmittance of at least 80% and at least 90% are even more useful.

The transparent conductive films according this invention provide transmittance of at least 70% across entire spectrum range of from about 350 nm to about 1100 nm, and surface resistivity of 500 ohm/sq or less.

Particularly useful are films with a transmittance of at least 85% and a surface resistivity of 500 ohm/sq or less.

The transparent conductive films comprising silver nanowires and cellulose acetate butyrate and cellulose acetate binders also show excellent clarity, high scratch resistance and hardness due to the high Tg values for cellulose polymers.

If desired, scratch resistance and hardness of the transparent conductive films with these binders to the support can be improved by using a crosslinking agent to crosslink the cellulose ester polymers. Isocyanates and alkoxylsilanes are examples of typical crosslinking agents for cellulose esters containing free hydroxyl groups.

### The Transparent Support:

In one embodiment, the conductive materials are coated onto a support. The support may be rigid or flexible.

Suitable rigid substrates include, for example, glass, polycarbonates, acrylics, and the like.

When the conductive materials are coated onto a flexible support, the support is preferably a flexible, transparent polymeric film that has any desired thickness and is composed of one or more polymeric materials. The support is required to exhibit dimensional stability during coating and drying of the conductive layer and to have suitable adhesive properties with overlying layers. Useful polymeric materials for making such supports include polyesters [such as poly(ethylene terephthalate) (PET), and poly(ethylene naphthalate) (PEN)], cellulose acetate and other cellulose esters, polyvinyl acetal, polyolefins, polycarbonates, and polystyrenes. Preferred supports are composed of polymers having good heat stability, such as polyesters and polycarbonates. Support materials may also be treated or annealed to reduce shrinkage and promote dimensional stability. Transparent multilayer supports can also be used.

Coating of the Conductive Films onto a Support:

Transparent conductive articles can be prepared by coating the organic solvent-based formulations described above onto a transparent support using various coating procedures such as wire wound rod coating, dip coating, air knife coating, curtain coating, slide coating, slot-die coating, roll coating, gravure coating, or extrusion coating.

Alternatively, transparent conductive articles can be prepared by laminating the transparent conductive films prepared as described above onto a transparent support.

In some embodiments, a “carrier” layer formulation comprising a single-phase mixture of two or more polymers may be applied directly onto the support and thereby located between the support and the silver nanowire layer. The carrier layer serves to promote adhesion of the support to the transparent polymer layer containing the silver nanowires. The carrier layer formulation can be sequentially or simultaneously applied with application of the transparent conductive silver nanowire layer formulation. It is preferred that all coating be applied simultaneously onto the support. Carrier layers are often referred to as “adhesion promoting layers”, “interlayers”, or “intermediate layers”.

As noted above, in one embodiment the coating weight of the silver nanowires is from about 20 mg/m² to about 500 mg/m². In other embodiments, coating weight of silver nanowires is from about 20 mg/m² to about 200 mg/m². Embodiments wherein the silver nanowires are coated at from about 30 mg/m² to about 120 mg/m² are also contemplated.

Upon coating and drying, the transparent conductive article should have a surface resistivity of less than 1,000 ohms/sq and preferably 500 ohm/sq or less.

Similarly, upon coating and drying on a transparent support, the transparent conductive article should have as high an optical transmittance as possible. A transmittance of at least 70% is useful. A transmittance of at least 80% and even at least 90% are even more useful.

Particularly preferred are articles with a transmittance of at least 70% and a surface resistivity of 500 ohm/sq or less.

The following examples are provided to illustrate the practice of the present invention and the invention is not meant to be limited thereby.

### Materials and Methods for the Experiments and Examples:

All materials used in the following examples are readily available from standard commercial sources, such as Aldrich Chemical Co. (Milwaukee, Wis.) unless otherwise specified. All percentages are by weight unless otherwise indicated. The following additional methods and materials were used.

CA 398-6 is a cellulose acetate resin available from Eastman Chemical Co. (Kingsport, Tenn.). It is reported to have a glass transition temperature of about 182° C.

CAB 171-15 and CAB 381-20 are cellulose acetate butyrate resins available from Eastman Chemical Co. (Kingsport, Tenn.). They are reported to have glass transition temperatures of 161° C. and 141° C. respectively.

CAP 482-20 is a cellulose acetate propionate resin available from Eastman Chemical Co. (Kingsport, Tenn.). It is reported to have a glass transition temperature of about 147° C.

CCP B03TX is a polyvinyl butyral resin available from Chang Chun Petrochemical Co. LTD (Taipei, Taiwan).

Desmodur N75 BA is an aliphatic polyisocyanate available from Bayer MaterialScience (Pittsburgh, Pa.).

Fomrez 11-112 is a hydroxyl terminated saturated linear polyester polyol available from Chemtura (Middlebury, Conn.).

PET is polyethylene terephthalate and is a support for the silver nanowire/polymer coatings. The terms support and substrate are used interchangeably.

PE 2700-LMW is a low molecular weight polyester resin available from Bostik Inc. (Middleton, Mass.).

Mayer Bars are ½ inch diameter Type 303 stainless steel coating rods and are available from R.D. Specialties, Inc. (Webster, N.Y.).

MEK is methyl ethyl ketone (or 2-butanone).

Silver nanowires were obtained from Seashell Technologies, LLC, (LaJolla, Calif.).

THDI is Desmodur N-3300 (2,2,4-trimethylhexamethylene diisocyanate) available from Bayer Material Science (Pittsburgh, Pa.).

BND is bismuth neodecanoate available from Sigma-Aldrich.

### Measurement of Resistivity

Surface resistivity was measured using an R—CHEK model RC2175 Surface Resistivity meter available from Electronic Design To Market, Inc. (Toledo, Ohio).

### Measurement of Percent Transmission

Transmission (%) was measured in accord with ASTM D 1003 by conventional means using a Haze-gard Plus Hazemeter that is available from BYK-Gardner (Columbia, Md.). To provide consistent transmission measurements, all samples within each Example were coated onto the same lot of support.

### Measurement of Adhesion

Samples were evaluated using a “cross-hatch” adhesion test performed according to ASTM D3359-92A. A coated film was cut with a razor blade in a cross-hatched pattern, a 1 inch (2.54 cm) wide piece of commercially available 3M Type 610 semi-transparent pressure-sensitive tape was placed on the pattern and then quickly lifted off. The amount of coating left on the film is the measure of adhesion. The adhesion test ratings are from 0 to 5 where 0 refers to complete removal of the coating and 5 refers none of the coating removed. A rating of “3” or greater is considered acceptable. 3M Type 610 semi-transparent pressure-sensitive tape was obtained from 3M Company (Maplewood, Minn.).

### Examples 1-11

### Preparation and Evaluation of Transparent Conductive Coatings

To a solution of 0.50 g of polymer premix solution, prepared as shown below in Table II, was added 0.40 g of MEK and 0.10 g of a silver nanowire dispersion in 2-propanol (5.09% silver nanowires).

The dispersion was mixed on a roller mixer for 10 minutes to obtain a uniform dispersion. The dispersion was coated onto a 7-mil (178 μm) clear polyethylene terephthalate support using a #10 Mayer rod. The resulting coating was dried in oven at 220° F. (104° C.) for 10 min to obtain a transparent film suitable for testing.

Samples were tested for surface resistivity, % transmission, and adhesion to the support as described above.

The results, shown below in TABLE I, demonstrate that transparent conductive films, coated from cellulose acetate, cellulose acetate butyrate, or cellulose acetate propionate have a much lower resistivity than transparent conductive films similarly prepared, but using either a polyvinyl butyral or a polyurethane binder.

Photographs of samples of films prepared in Examples 6, 9, and 10, were taken.

FIG. I is a photomicrograph of a transparent conductive film coated using cellulose acetate butyrate as the binder as described in Example 7. The photograph shows a uniform yet random network of interconnected silver nanowires dispersed within the cellulose acetate butyrate binder. This sample has good conductivity, transparency, and excellent adhesion to the PET support. The silver nanowires are well dispersed in the cellulose acetate butyrate polymer binder resulting in formation of a good percolation network and good conductivity.

FIG. II is a photomicrograph photograph of a transparent conductive film coated using polyvinyl butyral as the binder as described in Example 10. The photograph shows severe aggregation of silver nanowires in the polymer matrix, resulting coatings having poor conductivity.

FIG. III is a photomicrograph of a transparent conductive film coated using polyurethane as the binder as described in Example 11. The photograph shows severe aggregation of silver nanowires in the polymer matrix, resulting in coatings with poor conductivity.

TABLE I

| | | Silver Nanowire | Resistivity | Percent | | Adhesion |
|---|---|---|---|---|---|---|
| Example | Polymer | dimensions | (Ohm/square) | Transmittance | T/R ratio | to Support |
| PET Support | — | — | Non-conductive | 88.4 | — | — |
| 1-Inventive | CA-1 | 85 nm/14.7 μm | 80 | 81 | 1.01 | 2 |
| 2-Inventive | CA-2 | 85 nm/14.7 μm | 80 | 83 | 1.04 | 5 |
| 3-Inventive | CAB-1 | 85 nm/14.7 μm | 50 | 84 | 1.68 | 2 |
| 4-Inventive | CAB-2 | 85 nm/14.7 μm | 80 | 84 | 1.05 | 2 |
| 5-Inventive | CAB-3 | 85 nm/14.7 μm | 300 | 84 | 0.28 | 5 |
| 6-Inventive | CAB-4 | 110 nm/15 μm | 800 | 83 | 0.10 | 5 |
| 7-Inventive | CAB-4 | 85 nm/14.7 μm | 50 | 84 | 1.68 | 5 |
| 9-Inventive | CAP-1 | 85 nm/14.7 um | 50 | 83 | 1.66 | 1 |
| 8-Inventive | CAB-4 | 82 nm/11 μm | 1700 | 84 | 0.05 | 5 |
| 10-Non Inventive | PVB | 85 nm/14.7 μm | 1.5 × 10⁵ | 84 | 5.6 × 10⁻⁴ | 1 |
| 11-Non Inventive | PU | 85 nm/14.7 μm | Non-conductive | 86 | — | 5 |

TABLE II

| Polymer Premix | Polymer-1 | Polymer-2 | Crosslinker | Solvent |
|---|---|---|---|---|
| CA-1 | CA398-6 (8.0 g) | — | THDI (0.20 g) | MEK (210 g) |
| CA-2 | CA 398-6 (1.12 g) | — | THDI (0.30 g) | Ethyl acetate (10.5 g) |
| | | | dibutyltin dilaurate | Acetone (8.75 g) |
| | | | (0.015 g) | MEK (8.75 g) |
| CAB-1 | CAB 171-15 (8 g) | — | THDI (0.20 g) | MEK (210 g) |
| CAB-2 | CAB 381-20 (8 g) | | THDI (0.20 g) | MEK (210 g) |
| CAB-3 | CAB 381-20 (8 g) | PE5800 (1.6 g) | THDI (0.20 g) | MEK (210 g) |
| CAB-4 | CAB171-15 (4 g) | — | THDI (0.30 g) | MEK (26.9 g) |
| | | | Dibutyltin dilaurate | |
| | | | (0.015 g) | |
| CAP-1 | CAP 482-20 (8 g) | — | THDI (0.20 g) | MEK (210 g) |
| PVB | CCP B03TX (6 g) | PE2700B (2 g) | THDI (0.2 g) | MEK (210 g) |
| PU | Fomrez 11-112 (8 g) | Desmodur N75BA | dibutyltin dilaurate | MEK (290 g) |
| | | (4.25 g) | (0.03 g) | |

### Examples 12-23

Examples 12-23 demonstrate the versatility of cellulose acetate butyrate binder in different solvent systems using different crosslinker and catalyst formulations.

Preparation of Cellulose Acetate Butyrate Polymer Premix:

To a solution of 438 g MEK was added 12.0 g of cellulose acetate butyrate (CAB), 3.0 g THDI and 0.70 g crosslinker catalyst. The resulting mixture was mixed on a bottle shaker for 3 hours at room temperature to obtain the CAB premix solution.

Preparation and Transparent Conductive Film Coating:

To a solution of cellulose acetate butyrate premix was added additional solvents, and silver nanowire dispersion in 2-propanol (5.09% silver nanowires). The dispersion was coated onto a 4-mil (102 μm) clear polyethylene terephthalate support using a #10 Mayer rod. The resulting coating was dried in oven at 220° F. (104° C.) for 6 minutes to obtain a transparent film suitable for testing. These formulations are shown below in TABLE III.

The sheet resistivity (ohm/sq), percent light transmittance, and haze of each sample was measured. The results are shown below in TABLE IV.

TABLE III
Solvent and crosslinker systems for transparent conductive film.

| | Silver | | Iso- | | |
|---|---|---|---|---|---|
| Ex- | Nanowires | CAB | propyl | | Crosslink |
| ample | (g) | Premix | alcohol | Solvent (g) | Catalyst |
| 12 | 0.08 | 0.48 | 0.25 | N.N′-dimethyl | dibutyltin |
| | | | | formamide/0.03 | dilaurate |
| 13 | 0.12 | 0.48 | 0.25 | N.N′-dimethyl | dibutyltin |
| | | | | formamide/0.03 | dilaurate |
| 14 | 0.15 | 0.48 | 0.30 | N.N′-dimethyl | dibutyltin |
| | | | | formamide/0.03 | dilaurate |
| 15 | 0.12 | 0.50 | 0.10 | MEK/0.40 | dibutyltin |
| | | | | | dilaurate |
| 16 | 0.12 | 0.50 | 0.00 | MEK/0.30 | BND |
| 16 | 0.12 | 0.50 | 0.20 | MEK/0.30 | BND |
| 18 | 0.12 | 0.50 | 0.20 | Propyl Acetate/0.20 | BND |
| 19 | 0.12 | 0.50 | 0.20 | Ethyl Lactate/0.20 | BND |
| 29 | 0.12 | 0.50 | 0.20 | Ethyl Lactate/0.40 | BND |
| 21 | 0.12 | 0.36 | 0.40 | Ethyl Lactate/0.20 | BND |
| 22 | 0.20 | 0.36 | 0.32 | Ethyl Lactate/0.20 | BND |
| 23 | 0.12 | 0.50 | 0.20 | 2-Heptanone/0.20 | BND |
| 23 | 0.12 | 0.50 | 0.20 | 5-methyl-hexanone/ | BND |
| | | | | 0.20 | |

TABLE IV
Sample Properties

| | Resistivity | Percent | |
|---|---|---|---|
| Example | (ohm/sq) | Transmittance | Haze |
| 12 | 60 | 84 | 17 |
| 13 | 20 | 83 | 19 |
| 14 | 20 | 82 | 21 |
| 15 | 20 | 81 | 24 |
| 16 | 16 | 79 | 23 |
| 16 | 25 | 81 | 20 |
| 18 | 28 | 82 | 13 |
| 19 | 35 | 81 | 15 |
| 29 | 40 | 82 | 13 |
| 21 | 140 | 84 | 10 |
| 22 | 36 | 82 | 14 |
| 23 | 100 | 82 | 13 |
| 23 | 170 | 81 | 14 |

### Examples 24-59

Examples 24-59 demonstrate that the conductivity of the transparent conductive films described herein can be improved significantly upon treatment with heat and pressure.

Samples were heat and pressure treated using a heated drum processor of the type described in U.S. Pat. No. 6,007,971 (Star et al.), incorporated herein by reference. The processor includes a moveable heated drum capable of heating the transparent conductive film to at least a temperature above the glass transition temperature of polymer binder mixture of the transparent conductive film matrix. The heated drum also includes a resilient layer that is sufficiently thin and sufficiently thermally conductive so that the resilient layer rapidly heats the transparent conductive film. The heated drum processor also includes a number of rotatable rods positioned near the heated drum that press against the transparent conductive film sample and heated drum by applying a total biasing force to the transparent conductive film of from 1 to 200 g per cm of width. The heated drum is moveable and the pressure rods are rotatable at rates that approximately match the transport rate of the transparent conductive film.

Transparent conductive film samples was prepared in a manner similar to Example 13 in TABLE III. The coating weight of the samples was varied to give transparent conductive films having resistivity ranging from below 100 ohm/sq to over 100 ohm/sq. Samples were subjected to heat and pressure treatment for 15 seconds at either 130° C., 140° C., and 150° C. for 15 seconds. All samples were subjected to heat and pressure treatment within 24 hours of coating.

The resistivity before heat and pressure treatment, the resistivity after heat and pressure treatment, and the percent improvement in resistivity for each sample is shown in TABLE V. All samples showed improved resistivity after heat and pressure treatment.

TABLE V
Conductivity improvement after thermal processing

| | Initial | Resistivity After Hear and Pressure | | | |
|---|---|---|---|---|---|
| | Resistivity | Treatment (ohm/sq) | | | % |
| | (ohm/sq) | 130° C./ | 140° C./ | 150° C./ | Conductivity |
| Example | (as coated) | 15 sec | 15 sec | 15 sec | Improvement |
| 24 | 83 | 60 | — | — | 38% |
| 25 | 70 | 58 | — | — | 21% |
| 26 | 90 | 67 | — | — | 34% |
| 27 | 45 | 38 | — | — | 18% |
| 28 | 40 | 33 | — | — | 21% |
| 29 | 37 | 32 | — | — | 16% |
| 30 | 73 | 55 | — | — | 33% |
| 31 | 66 | 52 | — | — | 27% |
| 32 | 65 | 53 | — | — | 23% |
| 33 | 83 | 54 | — | — | 54% |
| 34 | 90 | 53 | — | — | 70% |
| 35 | 120 | 58 | — | — | 107% |
| 36 | 70 | — | 60 | — | 17% |
| 37 | 72 | — | 58 | — | 24% |
| 38 | 60 | — | 36 | — | 67% |
| 38 | 54 | — | 43 | — | 26% |
| 40 | 40 | — | 34 | — | 18% |
| 41 | 40 | — | 32 | — | 25% |
| 42 | 69 | — | 56 | — | 23% |
| 43 | 62 | — | 51 | — | 22% |
| 44 | 62 | — | 50 | — | 24% |
| 45 | 80 | — | 45 | — | 78% |
| 46 | 62 | — | 47 | — | 32% |
| 47 | 73 | — | 41 | — | 78% |
| 48 | 101 | — | — | 56 | 80% |
| 49 | 74 | — | — | 50 | 48% |
| 50 | 60 | — | — | 45 | 33% |
| 51 | 36 | — | — | 20 | 80% |
| 52 | 35 | — | — | 28 | 25% |
| 53 | 36 | — | — | 31 | 16% |
| 54 | 67 | — | — | 47 | 43% |
| 55 | 69 | — | — | 50 | 38% |
| 56 | 60 | — | — | 44 | 36% |
| 57 | 48 | — | — | 35 | 37% |
| 58 | 62 | — | — | 39 | 59% |
| 59 | 58 | — | — | 41 | 41% |

### Examples 60-66

Examples 60-66 demonstrate the stability of transparent conductive films under high temperature and high humidity under accelerated aging conditions.

Transparent conductive films were prepared in a manner similar to those of Example 19 in Table III. Samples were thermally processed at 130° C. for 15 seconds. The samples were then placed in an environmental chamber for 7 days with temperature and humidity maintained at 60° C. and 90% relative humidity, after which the resistivity of each sample were again measured. The resulting data, shown below in TABLE VI, demonstrates that the conductivity of transparent conductive films prepared from silver nanowires and cellulose acetate binders showed only small changes.

TABLE VI
Stability of Transparent Conductive Film after Storage
Under High Temperature/Humidity Conditions.

| | | Resistivity after | |
|---|---|---|---|
| | Initial | 7 days at | |
| | Resistivity | 60° C./90% RH | % Change in |
| Example | (ohm/sq) | (ohm/sq) | Resistivity |
| 60 | 83 | 82 | −1.2% |
| 61 | 87 | 86 | −1.1% |
| 62 | 92 | 100 | 8.7% |
| 63 | 310 | 298 | −3.9% |
| 64 | 329 | 357 | 8.5% |
| 65 | 422 | 463 | 9.7% |
| 66 | 1120 | 1192 | 6.4% |

1. A transparent conductive article comprising:
a transparent support having coated thereon;
a transparent conductive film comprising a random network of silver nanowires dispersed within a cellulose ester polymer.

2. The transparent conductive article of claim 1 wherein the transparent support is rigid or flexible.

3. The transparent conductive article of claim 1 wherein the transparent support is a flexible transparent polymer film.

4. The transparent conductive article of claim 1 wherein the support is a polyethylene terephthalate.

5. The transparent conductive article of claim 1 wherein the silver nanowires are present in an amount sufficient to provide a surface resistivity of less than 1000 ohm/sq.

6. The transparent conductive article of claim 1 wherein the silver nanowires have an aspect ratio of from about 20 to about 3300.

7. The transparent conductive article of claim 1 wherein the silver nanowires are present in an amount of from about 20 mg/m² to about 500 mg/m².

8. The transparent conductive article of claim 1 wherein the article has a transmittance of at least 70% and a surface resistivity of 500 ohm/sq or less.

9. The transparent conductive article of claim 1 having a transmittance of at least 70% across entire spectrum range of from about 350 nm to about 1100 nm and a surface resistivity of 500 ohm/sq or less.

10. The transparent conductive article of claim 1 wherein the cellulose ester polymer comprises cellulose acetate, cellulose acetate butyrate, or cellulose acetate propionate, or mixtures thereof.

11. The transparent conductive article of claim 1 wherein the cellulose ester polymer has a glass transition temperature of at least 100° C.

12. The transparent conductive article of claim 10 further comprising up to 50 wt % of an one or more additional polymers.

13. The transparent conductive article of claim 12 wherein the one or more of the additional polymers is a polyester polymer.

14. The transparent conductive article claims 10 further comprising a crosslinking agent.

15. The transparent conductive article of any of claims 1 having a transmittance of at least 70%.

16. The transparent conductive article of claim 1 having a transmittance of at least 70% across entire spectrum range of from about 350 nm to about 1100 nm.

17. The transparent conductive article claim 16 having a transmittance of at least 70% across entire spectrum range of from about 350 nm to about 1100 nm and a surface resistivity of 500 ohm/sq or less.

18. The transparent conductive article of claim 1 further comprising a transparent polymer layer located between the transparent support and the transparent conductive film.

19. A transparent conductive article comprising:
a transparent support comprising polyethylene terephthalate, having coated thereon;
a transparent conductive film comprising a random network of silver nanowires having an aspect ratio of at least 100 and dispersed within a cellulose acetate butyrate polymer in an amount sufficient to provide a surface resistivity of 500 ohm/sq or less.

20. A process for the formation of a transparent conductive article comprising:
preparing a dispersion of silver nanowires in a solution of a cellulose ester polymer;
coating the dispersion onto a transparent support; and
drying the coating on the support thereby forming a random network of silver nanowires.

21. The process of claim 20 wherein the transparent support is rigid or flexible.

22. The process of claim 21 wherein the transparent support is a flexible transparent polymer film.

23. The process of claim 22 wherein the support is a polyethylene terephthalate.

24. The process of claim 20 wherein the silver nanowires are present in an amount sufficient to provide a surface resistivity of less than 1000 ohm/sq.

25. The process of claim 20 wherein the silver nanowires have an aspect ratio of from about 20 to about 3300.

26. The process of claim 20 wherein the silver nanowires are present in an amount of from about 20 mg/m² to about 500 mg/m².

27. The process of claim 26 wherein the silver nanowires are present in an amount sufficient to provide a transmittance of at least 70% and a surface resistivity of 500 ohm/sq or less.

28. The process of claim 20 wherein the cellulose ester polymer comprises cellulose acetate, cellulose acetate butyrate, or cellulose acetate propionate, or mixtures thereof.

29. The process of claim 20 wherein the cellulose ester polymer has a glass transition temperature of at least 100° C.

30. The process of claim 29 further comprising up to 50 wt % of one or more additional polymers.

31. The process of claim 30 wherein the at least one or more of the additional polymers is a polyester polymer.

32. The process of claim 29 further comprising a crosslinking agent.

33. The process of claim 20 wherein a transparent polymer layer is coated between the transparent support and the transparent conductive layer.

34. A process for the formation of a transparent conductive film comprising:
preparing a dispersion of silver nanowires in a solution of a cellulose ester; and
coating and drying the dispersion thereby forming a random network of silver nanowires.

35. The process of claim 34 wherein the conductive film, has a transmittance of at least 70% across entire spectrum range of from about 350 nm to about 1100 nm and a surface resistivity of 500 ohm/sq or less.

36. A process for the formation of a transparent conductive article comprising:
preparing a dispersion of silver nanowires in a solution of a cellulose ester polymer;
preparing a carrier layer formulation comprising a single-phase mixture of two or more polymers;
coating the carrier layer formulation onto a transparent support;
coating, the dispersion of silver nanowires in a solution of a cellulose ester polymer, onto the carrier layer; and
drying the coating on the support, thereby forming a random network of silver nanowires.

37. The process of claim 36, wherein the carrier layer formulation and silver nanowire dispersion formulation are simultaneously coated onto the support.
